(19) United States
(12) Patent Application Publication
(10) Pub. No.: US 2010/0220378 A1
(43) Pub. Date: Sep. 2, 2010

(54) SELF-POWERING DISPLAY FOR LABELS AND CARDS

(75) Inventors: Martin Moeller, Dublin (IE); Henrik Lindstrom, Uppsala (SE); Michael Ryan, Dublin (IE); David Corr, Dublin (IE); Alain Briancon, Poolesville, MD (US); Micheal Cassidy, Dublin (IE)

Correspondence Address: VOLPE AND KOENIG, P.C., UNITED PLAZA, 30 SOUTH 17TH STREET, PHILADELPHIA, PA, 19103, US

(73) Assignees: NTERA, INC., Radnor, PA (US); NTERA LIMITED, Dublin (IE)

(21) Appl. No.: 12/738,039

(22) PCT Filed: Oct. 15, 2008
(86) PCT No.: PCT/US08/79958

§ 371 Date: Apr. 14, 2010

Related U.S. Application Data
(60) Provisional application No. 60/980,076, filed on Oct. 15, 2007.

(51) Int. Cl. G02F 1/153; G02F 1/163

(52) U.S. Cl. 359/268

(57) ABSTRACT

A device is disclosed that combines a battery system with an electrochromic system by judicious selection of electrodes and the connection of the appropriate electrodes to generate internal as well as external current flows. This system allows the elimination of a battery component reducing cost and improving manufacturing yield by reduction of the number of parts and number of interconnections. However, the design can be further extended to the combination of a battery system with a sensing system.

### FIELD OF INVENTION

This invention relates generally to a self powering display for use in devices such as smart labels, credit cards, smart cards, sensors, radio frequency identification (RFID) supported displays, touch sensitive displays, special purpose computer, disposable system, and also to consumer electronics devices and wireless communication devices having such displays.

### BACKGROUND

Various portable devices utilize a portable energy source such as one or more batteries. Other devices utilize near field communication supported by radio frequency (RF) waves. And still other devices utilize induction coupling to receive energy and support operations in a temporary ad-hoc matter. Notwithstanding improvements to both battery technology and power consumption of such devices, batteries are often needed to provide useful device life and enough energy headroom for advanced applications. Batteries can be cumbersome and limit the ability to create new and existing form factors.

For some devices, solar cells represent a viable supplemental or alternative energy source. Some devices, such as portable calculators, have both sufficiently large available surface area and sufficiently low power needs that some of these devices can be powered entirely by one or more solar cells. Unfortunately, many devices, such as labels, are used in indoor environments where the amount of environmental light is not sufficient to provide the energy required for sporadic or continuous operation. As a result, solar cells have not been viewed as a satisfactory power source for such devices.

Attempts to create a self powered display system have been focused on leveraging solar energy, such as described in U.S. Pat. No. 7,206,044; 6,518,944 or 5,153,760, where a solar cell is integrated mechanically with an LCD or Ch-LCD display. U.S. Application Publication No. 2007/0080925 integrates an electrochromic display with a solar cell. These supplemental or alternative energy sources do not work in the absence of light. Other “self-powering” displays have considered mechanical power as a source of power, such as described in U.S. Pat. No. 6,130,773, which describes piezoelectric power for reflective bistable displays. U.S. Pat. No. 3,940,205 uses an indium electrode to produce coloration in the layer of electrochromic material without the need for any external electrical power, but does not allow discoloration to be controlled.

Consequently, a continuing need exists for a way to supplement or replace battery power in devices, including wireless communications devices, in a commercially acceptable and cost-effective manner.

### SUMMARY

In an aspect, the invention provides a device capable of self powering or supplementing power. The device includes a first layer including at least one first electrode having a first material with a first redox potential; a second layer including at least one second electrode having a second material with a second redox potential, a metal oxide film, and a redox chromophore adsorbed to the metal oxide film; and a third layer including at least one third electrode having a third material with a third redox potential. The device also includes an electrolyte and the first, second, and third layers contact the electrolyte; a first switch electrically connecting the first and second layers; and a second switch electrically connecting the second and third layers. The first redox potential is more negative than the second redox potential and the third redox potential is more positive than the second redox potential.

In another aspect, the invention provides a method of operating a self-powering device. The method includes providing the device, the device including a first layer including at least one first electrode having a first material with a first redox potential; a second layer including at least one second electrode having a second material with a second redox potential, a metal oxide film, and a redox chromophore adsorbed to the metal oxide film; and a third layer including at least one third electrode having a third material with a third redox potential. The device further includes an electrolyte and the first, second, and third layers contact the electrolyte; a first switch electrically connecting the first and second layers; and a second switch electrically connecting the second and third layers. The first redox potential is more negative than the second redox potential and the third redox potential is more positive than the second redox potential. The method further comprising, charging the display device by opening the first and second switches.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 illustrates a principle of operation of a self-powering display sensor device.

FIG. 2 illustrates switching from the self-powering mode to the reference mode.

FIG. 3 illustrates layers and a separate reference electrode printed on a substrate.

FIG. 4 illustrates cathodic, electro-optic, and anodic layers.

FIG. 5 illustrates a configuration of electrode layers on three different planes.

FIG. 6 illustrates another configuration of electrode layers on a single plane.

FIG. 7 illustrates another configuration of electrode layers on a single plane. FIG. 7A illustrates the layers connected to switches and a display/sensor controller. FIG. 7B illustrates the layers connected to a display/sensor controller.

FIG. 8 illustrates layers on two planes where different layers on a single plane are interdigitated. FIG. 8A illustrates the layers top plan view of the two planes. FIG. 8B illustrates a side view of the two planes.

FIG. 9 illustrates a smart card with layers of electrodes.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made.

As used herein, “electro-optic layer” means a layer of a reflective display that provides an optical response to current or voltage, for example, an electrochromic display that includes an electrode and an electrochromic redox chromophore. In another example, an electro-optic layer in an electrophoretic display may include charged spheres that move under the influence of an electric field.

As used herein, “electrochomic redox chromophore,” “redox chromophore,” or “chromophore” means a substance or mixture of substances that engage in electrochemical reactions and undergoe a color change upon oxidation or reduction. Also as used herein, “changes color” or a “color change” means that the substance or mixture of substances obtains a new color, changes from clear to colored, or changes from colored to clear. The color change may be visible to the eye of an observer or detectable by instruments.

As used herein, a “electro-optically active electro-chromic electrode” or “electro-active” electrode is an electrode that includes a redox chromophore and participates in electrochemistry such that the redox chromophore enagages in redox chemistry and changes color.

As used herein, an “electro-optic effect” is a variation in the optical properties of a device based on the charge of the device. In some embodiments described, the electro-optic effect includes the consequence of the change in color of a redox chromophore on an electro-optically active electro-chromic electrode. The consequence can include a change in light scattering or light absorption of the region of the device affected. The consequence can also include a visible color or shade of color difference in the region of the device affected.

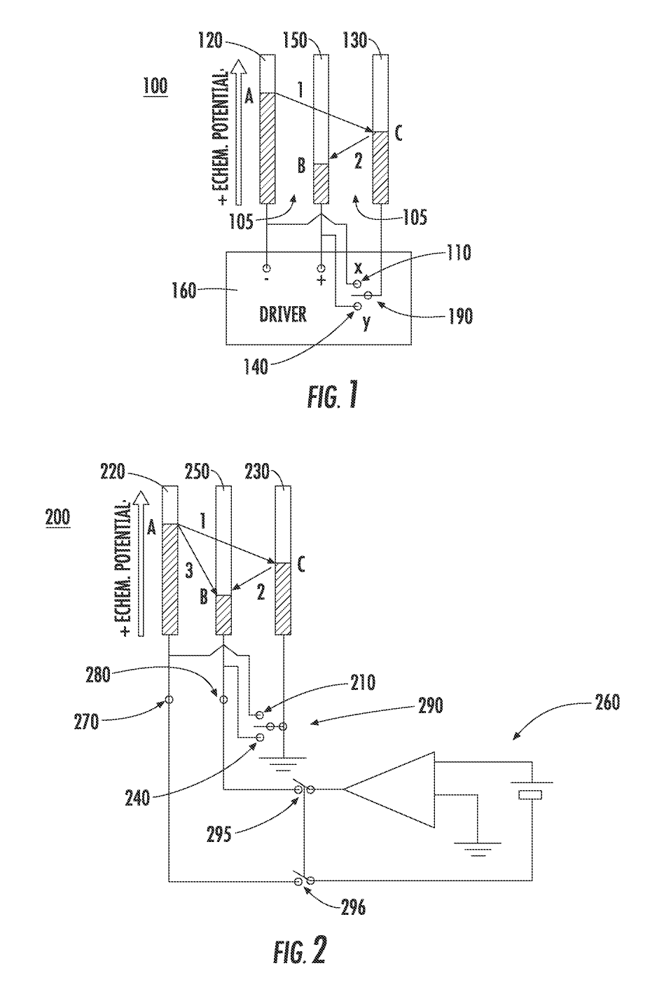

Referring to FIG. 1, the principle of operation of a self-powering display 100 of an embodiment is illustrated. Three electrodes are placed in contact with an electrolyte 105. The electrodes include substances that can engage in electrochemical reactions. The electrolyte 105 can be a common electrolyte or, as described below, the electrolyte can include different substances that can be liquid or solid. In a first state, the device is charged. Closing a switch 190 on post 110 allows electron transfer from electrode A 120 to electrode C 130, resulting in a second state. Upon transfer of the electron, an electro-optic material associated with electrode C is altered, which produces an electro-optic effect. Preferably, the material includes an electrochomic redox chromophore adsorbed to electrode C and the electro-optic effect includes a first color change of the chromophore. The color change can be referred to as a change from a first color that was present in the first state to a second color present in the second state. Once the chromophore is reduced, closing switch 190 on post 140 allows electron transfer to electrode B and oxidation of the chromophore, leaving the device in a third state. Upon oxidation, a second color change occurs that returns the chromophore to the color of the first state. The operation of switch 190 with respect to post 110 can be referred to as a first switch; and operation of switch 190 with respect to post 140 can be referred to as a second switch. The system is bistable at open-circuit (open switches 190/110 and 190/140) provided that no redox mediator is present in the electrolyte or mechanical shorts between electrodes are present. By opening and closing the switches, as described, the color of the electro-optic layer can be switched repeatedly between the first color and the second color. The structure illustrated in FIG. 1 provides the functionality of a display, a capacitor, and a battery. Functionality can be readily extended to also include a position/input sensor, as described below.

In a preferred embodiment, electrode A 120 is a Zn electrode, electrode B is a MgO₂ electrode, and electrode C 130 is a mesoporous TiO₂/viologen electrode, where viologen is the chromophore and changes as a consequence of participating in redox reactions. Alternate embodiments include other substances or combinations thereof as the redox chromophore or in addition to the redox chromophore. Subsequent to the electron transfer, some Zn²⁺ is generated (electrode-bound or electrolyte-bound). Once the viologen is colored, i.e., in its reduced form, closing switch 140 induces discoloration of the viologen, and concurrent reduction of a MnO₂ cathode 150. A cell with a zinc electrode 120 (electromotive force (emf)(A)=−0.8 V), a manganese dioxide electrode 150 (emf(B)=+0.6 V) and a TiO₂/viologen electrode 130 (emf(C)=−0.4 V) in an aqueous acidic electrolyte will self power and generate about 1.4 V for use by external devices such as a controller. Thus, switching of the viologen between the colored and the bleached state can occur simply by connecting electrodes A 120 and C 130 or B 150 and C 130 closing switches 110 or 140, respectively. This is possible because the net emf between the Zn electrode 120 and the viologen electrode 130 is of the opposite direction compared to the net emf between the MnO₂ electrode 150 and the viologen electrode 130.

Although the embodiment described above includes the Zn, TiO₂/viologen, and MnO2 electrodes, the principle outlined may be utilized to choose electrodes that include similar relative emfs; where electron transfer from a first electrode to a second electrode changes the color of a redox chromophore associated with the second electrode, and electron transfer from the second electrode to a third electrode also changes the color of a redox chromophore. The driver for such a self-powering system may be, but is not limited to, a driver of very low level complexity. This is possible because the operation requires only the control of a switch. Moreover, in another embodiment, stable electrode potentials of electrode A 120 and electrode B 150 could also be used as reference electrodes to control the potential of the electrochromic electrode C 130.

It is also possible to power an external controller which in turns controls the charges (or discharges). This implementation allows the operation of the system as a three-electrode system. In another embodiment, the self powering unit can be integrated with a label, smart card, or other device that has its own on power source. In this embodiment, different sources of power may be adapted to different functionalities within the device; akin to the management of computer batteries. In still another embodiment, an electrochromic display is optimized for its capacitive capabilities and, as a capacitor, changes color when charged.

The material for the anodes of the present embodiments can include Li, K, Ca, Na, Mg, Hg, Al, Zn, Cr or a combination, compound, amalgam, or alloy thereof. The material for the cathodes of the present embodiments can include Cu₂O, CuO, AgO, MnO₂ or a combination, compound, amalgam, or alloy thereof.

In a preferred embodiment, the electo-optic electrode includes a mesoporous, i.e., a nanoporous-nanocrystalline semiconducting metal oxide film. In still other preferred embodiments, the metal oxide can be one or more of the group of semi-conducting oxides including titanium, zirconium, hafnium, chromium, molybdenum, indium, niobium, tungsten, vanadium, niobium, tantalum, silver, zinc, strontium, iron (Fe²⁺ or Fe³⁺), nickel and a perovskite. Still more preferably, the metal oxide is selected from the group of metal conducting metal oxides including

(a) SnO₂ doped with F, Cl, Sb, P, As or B;

(b) ZnO doped with Al, In, Ga, B, F, Si, Ge, Ti, Zr or Hf;

(c) In₂O₃ doped with Sn;

(d) CdO

(e) Ternary oxides ZnSnO₃, Zn₂In₂O₅, In₄Sn₃O₁₂, GaInO₃ or MgIn₂O₄;

(f) TiO₂/WO₃ or TiO₂/MoO₃ systems; and

(g) Fe₂O₃ doped with Sb; and

(h) Fe₂O₃/Sb or SnO₂/Sb systems.

In preferred embodiments, a redox chromophore is absorbed or attached to a nanoporous-nanocrystalline semiconducting metal oxide film. The redox chromophore can, but is not limited to, one or more of the following compounds:

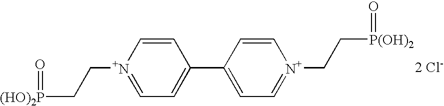

(1,1′-Bis-(2-phosphonoethyl)-4,4′-bipyridinium dichloride) Formula I,

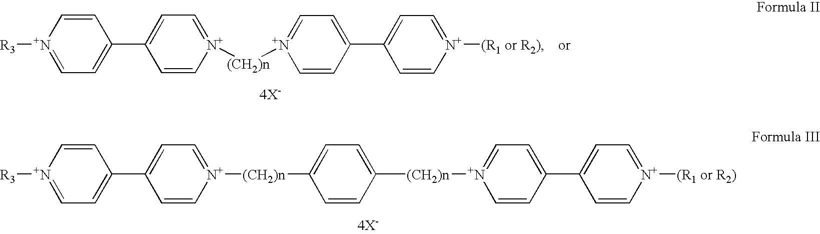

where R₁ is selected from the group consisting of:

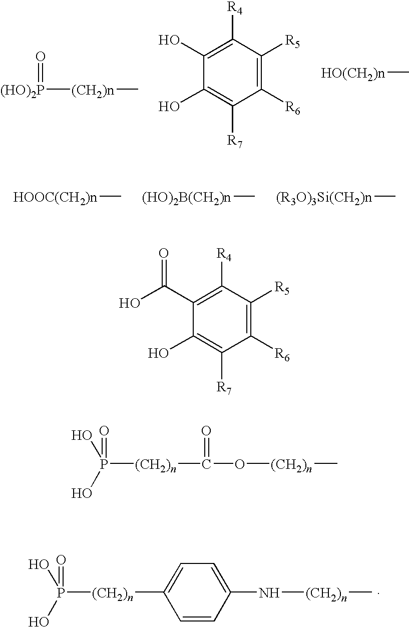

In the structures above, R₂ is selected from C₁₋₁₀ alkyl, N-oxide, dimethylamino, acetonitrile, benzyl, phenyl, mono-nitro substituted phenyl, and di-nitro substituted phenyl; R₃ is C₁₋₁₀ alkyl; and R₄-R₇ are each independently selected from hydrogen, C₁₋₁₀ alkyl, C₁₋₁₀ alkylene, aryl or substituted aryl, halogen, nitro, and an alcohol group. X is a charge balancing ion which is selected from the group consisting of chloride, bromide, iodide, BF₄⁻, PF₆⁻, and ClO₄⁻ and n=1-10.

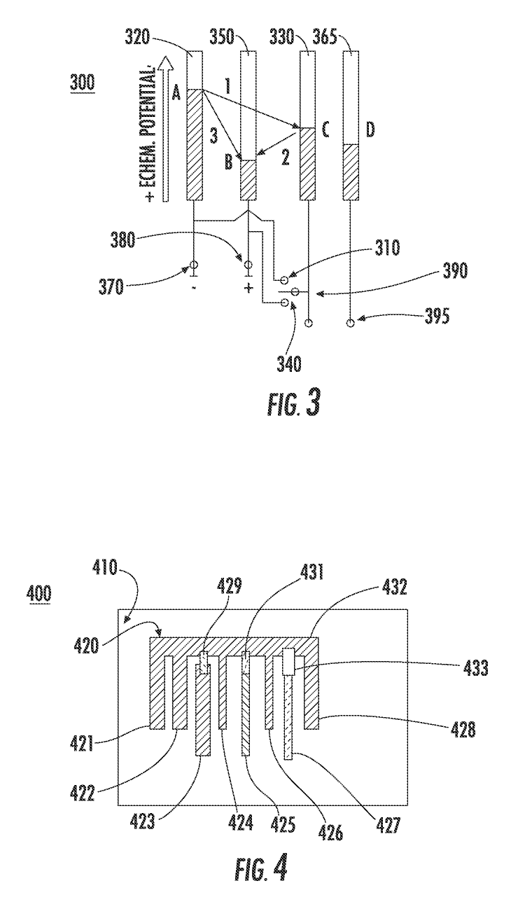

Referring to FIG. 2, a device 200 capable of operating with a reference electrode is illustrated. An electrode A 220 having a negative potential, an electrode C 230 with a negative potential that is not as great as the negative potential of electrode A 220, and an electrode B 250 with a positive potential. FIG. 2 also illustrates controller 260 and switches 290, 295, and 296; posts 210, 240; and connections 270, 280. As with the embodiment illustrated in FIG. 1, the operation of switch 290 with respect to post 210 can be referred to as a first switch and operation of switch 290 with respect to post 240 can be referred to as a second switch. In a preferred embodiment, electrode A 220 is a Zn electrode, electrode B 250 is an MnO₂ electrode 250, and electrode C 230 is a TiO₂ electrode 230.

In the embodiment illustrated in FIG. 2, the anodic electrode can also be used as a reference electrode, that is as an electrode that has a stable and well-known electrode potential. Switching from a self-powering mode to a reference mode can be controlled through the display controller 260 attached to the self powering display 200 with a reference electrode 230. Connecting switch 290 to pole 210 will result in the coloring of electrode 230. Connecting switch 290 to pole 240 will result in a forced discoloring of electrode 230. When charges are present on the electro-optic layer (e.g., TiO₂ electrode 230), a shift of the cathodic layer can occur. Without a reference electrode, the driving scheme might be limited to a current drive, where a current source is applied for a finite amount of time. When a reference electrode is utilized, the drive scheme can be a lower cost voltage driver. Greater stability of an electrode potential can be achieved by employing an electrolyte that is ionically conductive, but electronically isolating.

The embodiments illustrated in FIG. 2 can be used to manage the contrast ratio between segments. The segment could be seven segments of a numeric segment display in a smart card or thirteen segments of alphanumeric security card.

Referring to FIG. 3, an embodiment is illustrated with an electrode A 320 that has a negative redox potential, an electrode B that has a positive redox potential, and an electrode C 330 that has a redox potential between those of electrodes A 320 and B 350. Preferably, electrode A 320 is a Zn electrode, electrode B 350 is a MnO₂ electrode, and electrode C 330 is a TiO₂-redox chromophore electrode. As illustrated in FIG. 3, a display can also include a separate reference electrode 365. Switch 390, posts 310 and 340 and connectors 370, 380 are similar to the illustrated features labeled 290, 210, 240, 270, and 280 in FIG. 2. A display controller, as illustrated in FIG. 2, may also be adapted to the embodiment illustrated in FIG. 3. In such a configuration, post 395 can form a switch similar to switch 295. Preferred reference electrodes 365 include Silver/Silver Chloride (Ag/AgCl), Silver/Silver Nitrate (Ag/AgNO₃), or Zn.

In an embodiment, the number of switches achievable (without external recharging) depends on the charge capacity of electrodes A or B (e.g., Zn and MnO₂ electrodes), the contrast ratio (CR) target, and leakage currents. Consider a nominal film of MnO₂: molar mass=87 g/mol, density=5.0 g/cm³ and, thus, a molar volume=17.4 cm³/mol. The amount of charge available for this system is computed as follows. For a 4 μm porous layer (e.g., 25% MnO₂, 25% carbon and 50% porosity), the bulk MnO₂ is 1 μm (i.e., 10⁻⁴ cm). In such a layer, the volume/cm² electrode=10⁻⁴ cm·1 cm²=10⁻⁴ cm³; and the mol/cm² electrode=10⁻⁴ cm³/(17.4 cm³/mol)=5.75·10⁻⁶ mol. And the charge per cm² electrode=5.75·10⁻⁶ mol·9.65·10⁴ C/mol=550 mC, which is approximately 0.15 mAh. By way of comparison, paper batteries have about 2 mAh/cm²

Assume that a device according to an embodiment of the invention has a nominal 25 mm² (5 mm by 5 mm) icon deposited on the electro-optic electrode (e.g., the TiO₂ electrode 350), requires 1.5 mC/cm² charge density and is driven by a three volt IC device controller chip associated with this display (this chip can be a traditional IC or printed). One operation of the icon then uses 1.5 mC*0.25 cm² to charge the pixel and uses 0.4*3*1 for the controller for a total 1.6 mC. This system would support 550 mC/1.6 mC/cm²=350 switches. Exemplary but non-limiting examples of applications suitable for such an embodiment include a transportation stored value card or a smart label attached to a container. As illustrated above, a display device can be configured to selectively display information and generate electricity in each pixel or segment.

As stated above, a feature of a self-powering device in an embodiment of the invention is that electrodes A, B, and C are in contact with an ionic conductor (i.e., an electrolyte) in order to provide ionic conductivity between electrodes. Generically, one or more ionic conductor in contact with the electrodes is referred to as an electrolyte. However, the embodiments herein are not necessarily limited to one common electrolyte. Different types of electrolyte can contact different electrodes. Where different electrolytes are used, ion movement across the interface of two different electrolytes should be possible. Where a specific reference electrode is added, an electrolyte used in conjunction with the reference electrode can be of sufficient concentration to ensure that the equilibrium potential of the reference electrode is stable. In a preferred embodiment an electrode such as an Ag/AgCl electrode or Ag/AgNO₃ electrode is used in conjunction with a KCl electrolyte. In another embodiment, a porous protective membrane is placed around at least a portion of a reference electrode/electrolyte.

In an embodiment, a solid electrolyte layer that supports motion of ions between electrodes utilized. The solid electrolyte can be a polymer including an ionic compound such as Lithium. In a preferred embodiment, the solid electrolyte is a three dimensional structure such as gel with solvent (aqueous or organic) and salt. And in yet another preferred embodiment, the solid electrolyte is an ion or proton conductor such as a meta oxide cluster.

In another embodiment, different metals or metal oxides can be integrated in electrodes to form a more complex structure. This allows the creation of structures that are more flexible and adapted to specific form factor needs (such as a roll-able or conformable structure, or placement in a radio frequency identification (RFID) enabled system in a manner that is not detrimental to antenna performance). Different thicknesses of electrode materials can also be used.

Referring to FIG. 4, an embodiment of the invention is illustrated where electrodes are provided in different planes. A first plane 410 is illustrated underlying a second plane 420. An electrode can be a layer of material deposited, for example by printing, on a substrate. As illustrated, in FIG. 4, a layer of electrodes is provided on plane 420. An electrolyte or electrolyte combination connects the layers in plane 410, 420. Plane 410 can include layers of anodic or cathodic electrodes and plane 420 is adapted to include layers of electrodes that match. For example, if plane 410 includes a layer of Zn electrode(s), plane 420 may include a layer of TiO₂/viologen electrode(s) and MnO₂ electrode(s). The layers may be applied to individual substrates that overlie one another. Alternatively, layers can be applied side by side or one over another on a single substrate. In either case, layers can be operably connected by providing electrolyte that contacts the layers. An operable connection can also include holes in a substrate through which electrolyte can permeate and contact layers on different substrates or different portions of a single substrate.

As illustrated in FIG. 4, layer 420 can be printed, or otherwise constructed, to include one or more electrodes of varying structures. Electrodes on plane 420 can include different substances, for example, Metal A in electrodes 421, 422, 423, or 424; Alloy B in electrode 425, or Compound C in electrodes 426, 427, or 428. For example, a set of electrodes could include a metal oxide film while individual electrodes had different doping materials added to the film. The selection of electrode material can be designed to enhance electrical or electrochemical performance of the device by, for example, optimizing the porosity, conductivity, or reactivity of an individual electrode. In addition, metal connections, such as connectors 429 and 431 can be used to link an electrode to the bridge 432. Bridge 432 is part of the layer and includes conductive or electrode material, which links electrodes 421-428. In another embodiment, an insulated connector 433 includes an operable connection that links the electrode 427 to the bridge 432. The insulator can be adapted to provide protection of a metal connection from the electrolyte. A device with layered components and manufacture of such a device is described in U.S. application Ser. No. 12/077,789 (filed Mar. 21, 2008, titled “Display systems manufactured by co-manufacturing printing processes”), which is incorporated herein as if fully set forth.

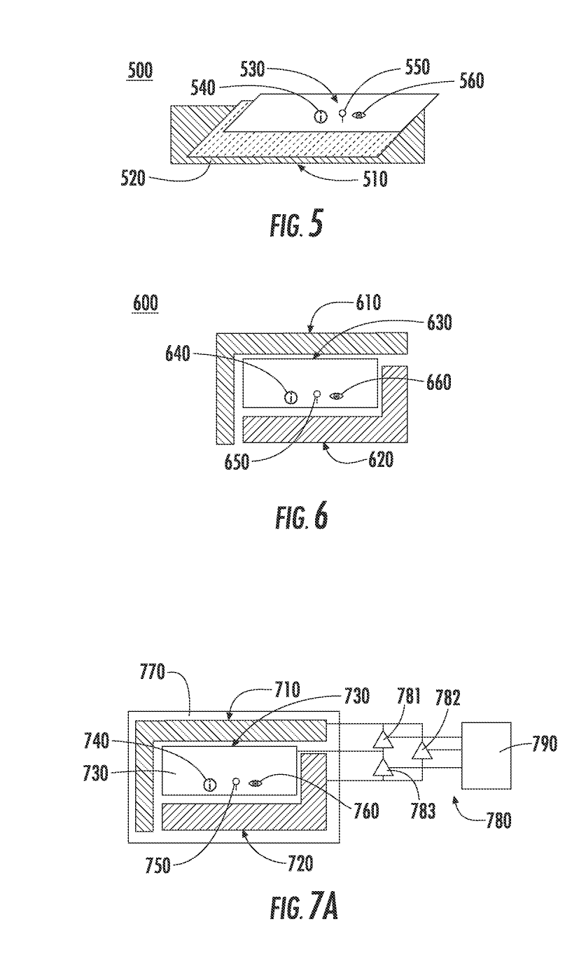

In embodiments where the change in a redox chromophore is monitored by an end user, the layers (cathodic, electro-optic, anodic) can be arranged in a manner that allows the electro-optic layer to be visible or otherwise detectable to the end user. Although the arrangement and number of layers is not limited, preferred embodiments include three layer configurations. Particular layer configurations are illustrated in FIGS. 5, 6, 7, and 8.

Referring to FIG. 5, a three plane device 500 is illustrated. An anodic layer 510 occupies a plane under a cathodic layer 520, which occupies a plane under an electro-active layer 530. The electro-active layer 530 occupies a layer above the other layers and can be presented to a user. Each layer can be varied in its depth, width and height to suit the particular application. For example, the electro-optic layer 530 may have an area on its plane that is smaller than the area of the underlying cathodic layer 520. The depth of each layer may be varied. For example, the cathodic or anodic layer may have a greater depth (i.e., a greater dimension in the direction perpendicular to the plane) than the remaining layers.

Displays/sensors 540, 550, and 560 are illustrated on layer 530. In one embodiment, the electro-active elements in the electro-active layer are utilized to display information and display/sensors 540, 550, or 560 are implemented as displays. In another embodiment, the electroactive elements can be used to provide information based upon their response to the environment, in which case display/sensors 540, 550, or 560 are implemented as sensors. Although discrete points are indicated by display/sensors 540, 550, 560, the points are representative of functions that can be incorporated in the electro-optic layer. In one embodiment, a visual presentation may be made provided across the electro-optic layer. In another embodiment, a first portion of the electro-optic layer may include one visual presentation and a second portion may include a second visual presentation. In still another embodiment, all or a portion of the electro-optic layer may be adpated to act as a sensor.

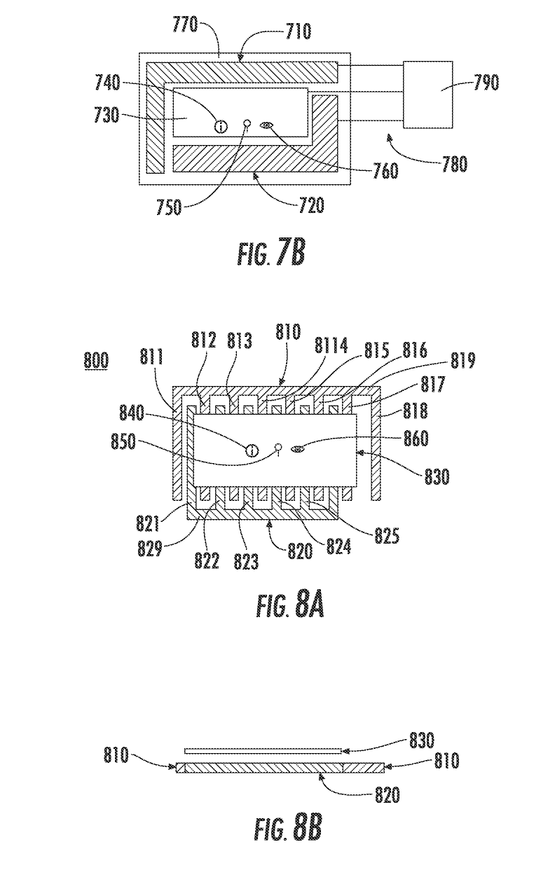

Referring to FIG. 6, single plane topology 600 is illustrated where three layers are printed on one plane. The anodic layer 610 frames the left and top portions of the plane. The cathodic layer 620 frames the right and bottom portions of the plane and the electro-active layer 630 occupies a central portion of the plane. Displays/sensors 640, 650, and 660 are illustrated within the electro-active layer 630. The control of a display can vary from a simple flip-flop like structure to a more complicated logic. Improvement in printed electronics allows part or all of the control circuitry of the present embodiments to be printed on the same substrate as the display/sensor/battery/capacitance structure. Such a device can be referred to as “display controlled.” As illustrated in FIG. 6, the single plane topology of the display can be adapted to be device controlled, although display controlled devices are not limited to this topology.

Referring to FIG. 7, two different embodiments of the single plane topology are illustrated in FIGS. 7A and 7B. In both FIGS. 7A and 7B, the anodic layer 710 frames the left and top portions of the plane. The cathodic layer 720 frames the right and bottom portions of the plane and the electro-active layer 730 occupies a central portion of the plane. Displays/sensors 740, 750, and 760 are illustrated within the electro-active layer 730. A substrate 770 is illustrated underlying the layers. FIG. 7A also illustrates switches 781, 782, and 783 which connect the layers and a display/sensor controller 790. FIG. 7B illustrates the display/sensor controller 790 connected to the layers.

In an embodiment, the electro-optic layer can be designed to absorb particular radiation with wavelengths in the electromagnetic spectrum. The wavelength(s) absorbed may correspond to light in the visible spectrum. As the layer absorbs light, a corresponding change in the electrode potential or of the photo-induced current may be detected by an external circuit. An external circuit 780 is illustrated in FIGS. 7A and 7B. Such a circuit may consist of a charge amplifier, generic op-amp or comparator. In a preferred embodiment, this circuitry is integrated with a display/sensor comptroller 790. By comparing the change or the rate of change of the electrode voltage or current, a change in the light level on the electro-optic layer may be detected that corresponds to a change in the ambient conditions. Such a change may be the exposure of the sensor/display to UV light, which could be used, for example, to warn that a perishable product was stored in sub-optimal conditions during transit.

In another embodiment, the electrochromic layer can be used as a sensor to detect input by a user. Preferably, as the layer absorbs light of particular wavelengths, a corresponding change in the electrode potential or of the photo-induced current may be detected by an external circuit. Such a circuit may consist of a charge amplifier, generic op-amp or comparator. By comparing the change or the rate of change of the electrode voltage or current, a change in the light level on the sensor/display may be detected that corresponds to a user input. For example, when a user's finger covers the sensor, incident light on the electrode could be reduced and detected as a means of sensing. The indication of the user's touch can be monitored or converted to a user input. Multiple detection areas can also be included, where a change in incident light in one area with respect to other sensor areas in the system may be used to provide location information about an input. Such an embodiment could allow for multiple functionalities for user inputs.

In another embodiment, the sensor may detect pressure. Pressure may be detected by including pressure sensors, piezoelectric sensors, or the like in the sensor. Also, pressure sensing can be affected by tracking the operation of switches within the device. Pressure sensor can be linked to a controller such that pressure information is recorded. The information can be recorded in memory attached to the device physically or remotely through wireless technology. In addition, pressure detection can be converted to operation of the display moieties of the device such that the device is optically altered in response to pressure.

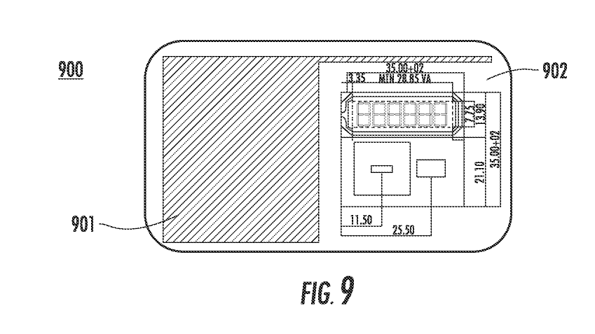

The size of different layers areas does not have to be the same. The size of particular layers can be adapted to balance user visible area and power generation capabilities. Referring to FIG. 8, a two plane topology 800 embodiment is illustrated. An anodic layer 810 includes arms 811, 812, 813, 814, 815, 816, 817, and 818 connected to bridge 819. Bridge 819 includes electrode material and links arms 811-818. A cathodic layer 820 includes arms 821, 822, 823, 824, 825, and 826 connected to bridge 829. Arms 821, 822, 823, 824, 825, and 826 are interdigitated with arms 811, 812, 813, 814, 815, 816, and 817. Each arm may be a separate electrode or the entire layer 810 or 820 may act as a single electrode.

Referring to FIG. 9, and embodiment is illustrated where the display is part of a smart card 900. Smart cards often require a thin batter but under the present embodiments, card 900 does not necessarily require a thin battery. In this embodiment, a first area 910 of thick cathodic and anodic layers 901 is in one portion of the card 900, and a second area 902 with thin cathodic and anodic layers is another portion of card 900. In addition, the electro-active layer is added to the second area 902. The size and placement of the areas is merely present as a non-limiting example. The thickness of the layers in the areas can be adjusted to control the overall thickness and topology of the card. In one embodiment, a uniform card thickness is provided. Alternatively, an additional layer, including electrodes, electrolyte, or filler, can be added on top of the structure to provide the desired thickness at separate points of the card. Varying the thickness of the layers facilitates processing of the card by lamination.

In order to avoid rapid self-discharge, with short battery life as a consequence, at least the electron donator electrode (for example, electrode A 120) or the electron acceptor electrode (for example, electrode B 150) can be sufficiently isolated from other electrodes. In FIG. 1, switches 110, 140 are associated with driver 160 and can be operated to isolate the electrodes. The embodiment depicted in FIG. 7 could be adapted to include a battery. In this embodiment, external circuit 780, includes switches 781, 782, and 783 that may be utilized to isolate electrodes. See also FIG. 2, which illustrates a power source and switches 210, 240, 270, 280, 290, 295, and 296. To extend the battery, electro active species can be removed or minimized in the electrolyte, and direct electrical shorts between the electrodes should be minimized. Also, to control the functionality of the electrode system, it is preferred to control the degree and nature of the circuit between the electrodes.

In a preferred embodiment, printing techniques, e.g., flexography, lithography, screen printing, inkjet printing or rotogravure printing, are utilized to deposit different layers onto substrates. More preferably, more than one layer and or all layers are printed on the same substrate.

Optimal electrochemical communication depends on the dimensions of the electro-optic electrode. In a preferred embodiment, electrochemical communication between layers and a compact and space saving architecture, is achieved by printing all layers on top of each other. In addition, intermediate separation layers can be added to avoid direct electric shorts or to control short circuit resistances between specific layers. In a preferred embodiment, separation layers are included and applied by a printing technique. In such a structure, separation layers can be porous over at least a portion of the separation layer. The porous structure can facilitate ionic conductivity between the different electrode layers. In another embodiment, one electrolyte can be used between electrodes layers A and B and a different electrolyte between electrode layers B and C. It is also possible, that each of the three electrode layers is in contact with a different electrolyte. In such embodiments, different compatible electrolytes can be chosen such that ionic conductivity, and therefore electrochemical communication, is possible between the three different layers.

In an embodiment, electrodes in anodic and cathodic electrode layers could be connected via an electrolyte including NH₄Cl or KOH and the electrolyte between cathodic and electro-active electrodes could be a Li salt or an Ionic liquid. In an embodiment, where electrodes are also connected to an external power source, and thus the third electrode is a (pseudo) reference electrode, a separate electrolyte can be used. In an embodiment, the electrolyte between an anode and cathode could be any of the electrolytes stated previously for electrochromic systems while the ionic media surrounding the reference electrode (e.g., Ag/AgCl) could be a high concentration of KCl. In a further embodiment, the reference electrode could also be encased in a protective membrane to avoid interaction with the anodic Zn electrode.

As previously described, embodiments of the invention include a device that includes a device controllers. One or more controller may be provided. The controller can be a single integrated circuit. In a preferred embodiment, the controller can be operated without contact, for example, the controller may be operated through wireless technology. Micro-switches can be connected to the display controller and to the one or more layers. The switches can be selectively opened to provide high external impedance, or closed to provide low external impedance between layers. A charger can also be connected to the device through switches or the controller. In a preferred embodiment, the controller allows a change in switches or connections between layers such that the anodic layer can be switched from being a charge source to being a reference electrode. In another preferred embodiment, the controller can change the electro-optic properties of the electro-optic layer. In another preferred embodiment, the controller can change the electro-optic properties of every electrode within the electro-optic layer such that substantially all or all of the redox chromophore is in one redox state. In another embodiment the controller can change the connection between the anodic and electro-optic layers such that a portion of the redox chromphore charged is changed. In one example, 5% of the charge on the redox chromphore is changed. In another embodiment, the controller may provide energy from the device to an external component.

The controller can be provided in different configurations. In one embodiment, the controller is partially printed on the same substrate as the display. In another embodiment, the controller is wholly printed on the same substrate as the display.

As previously described, a device of the embodiments herein may include sensors. In an embodiment, one or more sensors detect and provide environmental information to the device controller. The sensors can be part of the electo-optic layer or provided as an external sensor. The data sensed through the a sensor can be one or more of pressure, temperature, time, humidity, on time, on state, off time, off state, gradation level, voltage, current, charge, electromagnetic fields, electrokinetic effects, light, spectral shape, and presence of particular chemical compounds.

In an embodiment, a device of the embodiments herein may also include one or more additional batteries for storing electrical energy, one or more display lights, one or more additional capacitors for storing or recycling electrical energy, or a communication modem. In a preferred embodiment, the device includes a communication modem and the modem is a wireless modem.

In an embodiment, a change in the charge stored on the redox chromophore can be used as a skin tone for a device.

Electrodes and layers can be operatively connected with a passive matrix, active matrix, or a mixture of passive and active components.

In an embodiment, a device includes a controller through which a user can input display information and the controller defines command signals. The command signals can be sent to one or more pixels within the electro-optic layer such that the pixels change color; one or more pixels can be set to a display mode. In addition, the command signals can cause power to be collected; one or more pixels can be set to a charging mode.

### EMBODIMENTS

The following list includes particular embodiments of the present invention. The list, however, is not limiting and does not exclude alternate embodiments, as would be appreciated by one of ordinary skill in the art.

1. A device comprising:

a first layer including at least one first electrode having a first material with a first redox potential;

a second layer including at least one second electrode having a second material with a second redox potential, a metal oxide film, and a redox chromophore adsorbed to the metal oxide film; and

a third layer including at least one third electrode having a third material with a third redox potential;

the device further includes an electrolyte and the first, second, and third layers contact the electrolyte; a first switch electrically connecting the first and second layers; and a second switch electrically connecting the second and third layers; and

the first redox potential is more negative than the second redox potential and the third redox potential is more positive than the second redox potential;

2. The device of embodiment 1 having a first state where the first and second switches are open, the device is charged, and the redox chromophore is oxidized and has a first color.

3. The device of embodiment 1 having a second state where the first switch is closed and an electron from the first electrode is transferred to the second electrode, in the second state, the redox chromophore is reduced, undergoes a first color change, and has a second color.

4. The device of embodiment 1 having a third state wher the second switch is closed and an electron is transferred from the second layer to the third layer, in the third state, the redox chromophore undergoes a second color change to return to the first color.

5. The device of any one of the preceding embodiments, further comprising a plurality of independent pixels or segments and each independent pixel or segment includes one or more of the at least one second electrode.

6. The device of any one of the preceding embodiments wherein the first, second, and third layers are located on the same physical plane.

7. The device of any one of the preceding embodiments wherein the first and third layers are interdigated in a first plane and the second layer is in a second plane.

8. The device of any one of the preceding embodiments, wherein the first layer occupies a first plane, the second layer occupies a second plane, and the third layer occupies a third plane; the first plane between the second and third planes.

9. The device of any one of the preceding embodiments, wherein the first layer occupies a first plane, the second layer occupies a second plane, and the third layer occupies a third plane; the third plane between the first and second planes.

10. The device of any one of the preceding embodiments, wherein the first material includes a substance selected from the group consisting of Li, K, Ca, Na, Mg, Hg, Al, Zn, and Cr.

11. The device of any one of the preceding embodiments, wherein the first material includes Zn.

12. The device of any one of the preceding embodiments, wherein the second material includes a nanoporous-nanocrystalline semiconducting metal oxide film and the redox chromophore is adsorbed to the nanocrystalline semiconducting metal oxide film.

13. The device of embodiment 12, wherein the nanoporous-nanocrystalline semiconducting metal oxide film is a mesoporous TiO₂ film.

14. The device of any one of the preceding embodiments, wherein the third material includes a substance selected from the group consisting of Cu₂O, CuO, AgO, and MnO₂.

15. The device of any one of the preceding embodiments, further comprising a reference electrode operably connected to the device and having a substance selected from the group consisting of Zn, Ag/AgCl, and Ag/AgNO3.

16. The device of any one of the preceding embodiments, wherein the redox chromophore is a viologen.

17. The device of any one of the preceding embodiments, wherein the electrolyte includes a solid electrolyte layer that supports motion of ions between the first and the second layer.

18. The device of any one of the preceding embodiments, wherein the solid electrolyte is a polymer with a ionic compound such as Lithium.

19. The display device of any one of the preceding embodiments, further comprising one or more batteries for storing electrical energy.

20. The display device of any one of the preceding embodiments, further comprising a display light.

21. The display device of any one of the preceding embodiments, further comprising one or more capacitors.

22. The device of any one of the preceding embodiments, further comprising one or more controllers operably connected to one or more of the first, second, or third layers.

23. The device of embodiment 22, wherein the at least one of the device controllers is a single integrated circuit.

24. The display device of any one of embodiments 22-23, wherein the device controller can change the connection between electrodes such that the at least one first electrode becomes a reference electrode.

25. The device of any one of embodiments 22-24 further comprising one or more sensors for delivering information to the controller.

26. The device of embodiment 25 where information sensed through the sensor includes one or more parameter selected from the group consisting of pressure, temperature, time, humidity, on time, on state, off time, off state, gradation level, voltage, current, charge, electromagnetic fields, electrokinetic effects, light, spectral shape, chemical compounds.

27. The display device of any one of embodiments 22-26, further comprising a communication modem operably connected to the controller.

28. A method of operating the device according to any one of embodiments 22-27, the method comprising:

(a) inputting display information to the controller;

(b) defining command signals based on the display information;

(c) sending the command signals from the device controller to one or more pixels on the second layer;

(d) displaying the display information on the one or more display pixels based on the command signals; and

(e) collecting electric power from the second and third layers based on the command signals.

29. A method of operating a self-powering device comprising: providing the device, the device including a first layer including at least one first electrode having a first material with a first redox potential;

a second layer including at least one second electrode having a second material with a second redox potential, a metal oxide film, and a redox chromophore adsorbed to the metal oxide film; and

a third layer including at least one third electrode having a third material with a third redox potential;

the device further includes an electrolyte and the first, second, and third layers contact the electrolyte; a first switch electrically connecting the first and second layers; and a second switch electrically connecting the second and third layers; and

the first redox potential is more negative than the second redox potential and the third redox potential is more positive than the second redox potential;

the method further comprising, charging the display device by opening the first and second switches.

30. The method of embodiment 29 further comprising closing the first switch to transfer an electron from the first electrodes to the second electrodes and reduce the redox chromophore.

31. The method of embodiment 30 further comprising closing the second switch to transfer an electron from the second electrodes to the third electrodes and oxidize the redox chromophore.

32. A device comprising:

A first electro-optic layer;

A second layer of electrodes configured to add charges to the electro-optic layer and change an electrically controlled characteristic of the electro-optic layer;

A third layer of electrodes configured to remove charges from the electro-optic layer and change the electrically controlled characteristic of the electro-optic layer; and produce or store electrical energy through electro-chemical operation with the second layer.

33. A device as in embodiment 32 where the electro-optic layer consists of at least one electro-optically active electro-chromic electrode.

34. A device as in any one of embodiments 32-33 where the electro-optic effect is a variation of at least one light absorption or scattering characteristic of corresponding sections of the electro-optic layer.

35. A device as in any one of embodiments 32-34 where one of a plurality of independent pixels or segments have an electro-optic effect.

36. A device as in any one of embodiments 32-35 where the second layer is one or multiple anodes with a more negative reduction potential compared to the electro-optic layer electrode suitable to reduce the electro-chromic electrode on the first layer when it is in the oxidised form.

37. A device as in any one of embodiments 32-36 where the third layer is composed of one or more cathodes with a more positive reduction potential compared to the electro-optic electrode suitable to oxidise the electro-chromic electrodes when it is in the reduced form.

38. A device as in any one of embodiments 32-37 where the material for the anodes is either: Li, K, Ca, Na, Mg, Hg, Al, Zn, Cr or a combination/compound/amalgam/alloy thereof

39. A device as in any one of embodiments 32-38 where the material for the cathodes is either Cu₂O, CuO, AgO, MnO₂ or a combination/compound/amalgam/alloy thereof

40. A device as any one of embodiments 32-39 where a redox chromophore is absorbed or attached to a nanoporous-nanocrystalline semiconducting metal oxide film.

41. A device as in any one of embodiments 32-40 wherein the metal oxide is selected from a group of semi-conducting oxides consisting of titanium, zirconium, hafnium, chromium, molybdenum, indium, niobium, tungsten, vanadium, niobium, tantalum, silver, zinc, strontium, iron (Fe²+ or Fe³+), nickel and a perovskite.

42. A device as in any one of embodiments 32-41 wherein the metal oxide is selected from the group of metal conducting metal oxides consisting of:

(a) SnO₂ doped with F, Cl, Sb, P, As or B;

(b) ZnO doped with Al, In, Ga, B, F, Si, Ge, Ti, Zr or Hf;

(c) In₂O₃ doped with Sn;

(d) CdO

(e) Ternary oxides ZnSnO₃, Zn₂In₂O₅, In₄Sn₃O₁₂, GaInO₃ or MgIn₂O₄;

(f) TiO₂/WO₃ or TiO₂/MoO₃ systems; and

(g) Fe₂O₃ doped with Sb; and

(h) Fe₂O₃/Sb or SnO₂/Sb systems.

43. A device as in any one of embodiments 32-42 wherein the redox chromophore includes one or more substance selected from the group consisting of:

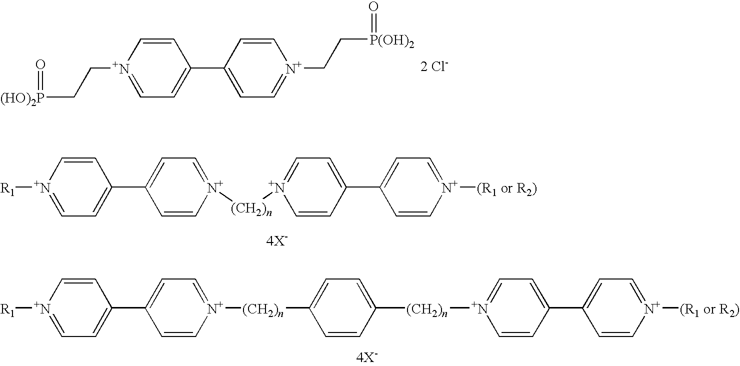

wherein R₁ is selected from the group consisting of:

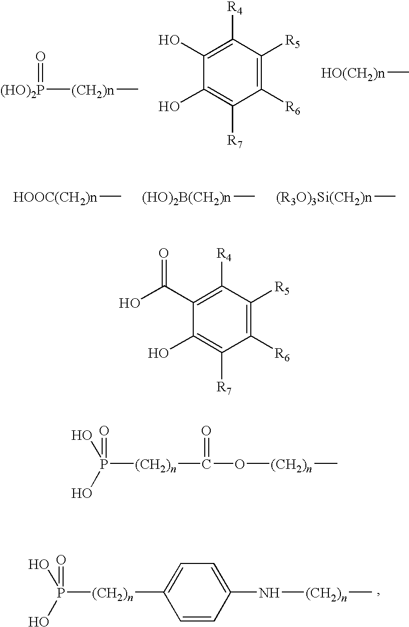

R₂ is selected from C₁₋₁₀ alkyl, N-oxide, dimethylamino, acetonitrile, benzyl and phenyl optionally mono- or di-substituted by nitro; R₃ is C₁₋₁₀ alkyl and R₄-R₇ are each independently selected from hydrogen; C₁₋₁₀ alkyl; C₁₋₁₀ alkylene; aryl or substituted aryl; halogen; nitro; and an alcohol group; and X is a charge balancing ion which is selected from the group consisting of chloride, bromide, iodide, BF₄⁻, PF₆⁻, and ClO₄⁻ and n=1-10.

44. A device as in any one of embodiments 32-43, further comprising a solid electrolyte layer that supports motion of ions between the first and the second layer.

45. A device as in any one of embodiments 32-44, further comprising a solid electrolyte layer supports motion of ions between the first and the third layer.

46. A device as in embodiments 44 or 45 where the solid electrolyte is a polymer with a ionic compound such as Lithium.

47. A device as in embodiments 44 or 45 where the solid electrolyte is a three dimensional structure such as gel with solvent (aqueous or organic) and salt.

48. A device as in embodiments 44 or 45 where the solid electrolyte is polymer that allows the movement of ions.

49. A device as in embodiments 44 or 45 where the solid electrolyte is a ion or proton conductor such meta oxide cluster.

50. A device as in any one of embodiments 32-49 where the electro-optic layer is used to detect changes in the ambient conditions by monitoring changes in the incident radiation through means of an external detection circuit.

51. A device as in any one of embodiments 32-49 where the electro-optic layer is used to detect user input by monitoring changes in the incident radiation on part or all of the sensor area(s) through means of an external detection circuit.

52. A device as in any one of embodiments 32-51 where the three layers are collocated on the same physical plane.

53. A device as in any one of embodiments 32-52 where the anodic and cathodic layers are interdigated in a single plane and the electro-optic in a separated plane.

54. A device as in any one of embodiments 32-51 where the anodic layer is a layer with holes within or between electrodes in one plane and sandwiched between electro-optic layer plane and the cathodic layer plane.

55. A device as in any one of embodiments 32-51 where the cathodic layer is a layer with holes within or between electrodes in one plane and sandwiched between electro-optic layer plane and anodic layer plane.

56. A device as in any one of embodiments 54-55 where the thickness of the elements of the different layers are set to provide an essentially constant thickness of the device.

57. A device as in any one of embodiments 32-56, further comprising one or more device controllers.

58. A device as in any one of embodiments 32-57, further comprising micro-switches connected to the display charger controller and to the one or more layers.

59. A device as in any one of embodiments 32-58, wherein the display pixels are configured to selectively display information and generate electricity.

60. A device as in any one of embodiments 57-59, wherein at least one of the one or more device controllers controls the electro-optic effect of the electro-optic first layer.

61. A device as in any one of embodiments 57-60, wherein a transition of the at least one device controller can affect the first and the second layer to transform substantially all of the redox chromophore moieties in a electro-optic area from a first redox state to a second redox state.

62. A device as in any one of embodiments 57-61, wherein a transition of the at least one device controller can affect the first and the third layer can to transform substantially all of the redox chromophore moieties in a electro-optic area from the second redox state to the first redox state.

63. A device as in any one of embodiments 57-60, wherein a transition of the at least one device controller can affect the first and the second layer to change the charge stored on the redox chromophore moieties in a electro-optic area by less than 5%

64. A device as in embodiment 63, wherein the change the charge stored on the redox chromophore moieties is used as a skin tone.

65. A device as in any one of embodiments 57-64, wherein the device controller operation is triggered through a logic associated with the operation of a contact-less communication standard.

66. A device as in embodiment 64, wherein a transition of the device controller can affect the second and the third layer to provide energy to one or more external component.

67. A device as in embodiment 66, wherein the one or more components are passive

68. A device as in embodiment 66, wherein the components are a mixture of active and passive components.

69. A device as in any one of embodiments 66-68 further comprising micro-switches connected to a display charger controller and to one or more electrodes layers.

70. A device as in embodiment 69, wherein the micro-switches may be selectively open to provide high external impedance, or closed to provide low external impedance between layers.

All references cited herein are incorporated by reference as if fully set forth.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A device comprising:
a first layer including at least one first electrode having a first material with a first redox potential;
a second layer including at least one second electrode having a second material with a second redox potential, a metal oxide film, and a redox chromophore adsorbed to the metal oxide film; and
a third layer including at least one third electrode having a third material with a third redox potential;
the device further includes an electrolyte and the first, second, and third layers contact the electrolyte; a first switch electrically connecting the first and second layers; and a second switch electrically connecting the second and third layers; and
the first redox potential is more negative than the second redox potential and the third redox potential is more positive than the second redox potential.

2. The device of claim 1 having a first state where the first and second switches are open, the device is charged, and the redox chromophore is oxidized and has a first color.

3. The device of claim 1 having a second state where the first switch is closed and an electron from the first electrode is transferred to the second electrode, in the second state, the redox chromophore is reduced, undergoes a first color change, and has a second color.

4. The device of claim 1 having a third state where the second switch is closed and an electron is transferred from the second layer to the third layer, in the third state, the redox chromophore undergoes a second color change to return to the first color.

5. The device of claim 1, further comprising a plurality of independent pixels or segments and each independent pixel or segment includes one or more of the at least one second electrode.

6. The device of claim 1 wherein the first, second, and third layers are located on the same physical plane.

7. The device of claim 1 wherein the first and third layers are interdigated in a first plane and the second layer is in a second plane.

8-9. (canceled)

10. The device of claim 1, wherein the first material includes a substance selected from the group consisting of Li, K, Ca, Na, Mg, Hg, Al, Zn, and Cr.

11. (canceled)

12. The device of claim 1, wherein the second material includes a nanoporous-nanocrystalline semiconducting metal oxide film and the redox chromophore is adsorbed to the nanocrystalline semiconducting metal oxide film.

13. (canceled)

14. The device of claim 1, wherein the third material includes a substance selected from the group consisting of Cu₂O, CuO, AgO, and MnO₂.

15. The device of claim 1, further comprising a reference electrode operably connected to the device and having a substance selected from the group consisting of Zn, Ag/AgCl, and Ag/AgNO₃.

16. (canceled)

17. The device of claim 1, wherein the electrolyte includes a solid electrolyte layer that supports motion of ions between the first and the second layer.

18. (canceled)

19. The display device of claim 1, further comprising one or more batteries for storing electrical energy.

20. (canceled)

21. The display device of claim 1, further comprising one or more capacitors.

22. The device of claim 1, further comprising one or more controllers operably connected to the first, second, and third layers.

23-24. (canceled)

25. The device of claim 22 further comprising one or more sensors for delivering information to the controller.

26. The device of claim 25 where information sensed through the sensor includes one or more parameter selected from the group consisting of pressure, temperature, time, humidity, on time, on state, off time, off state, gradation level, voltage, current, charge, electromagnetic fields, electrokinetic effects, light, spectral shape, chemical compounds.

27. (canceled)

28. A method of operating the device according to claim 22, the method comprising:
(a) inputting display information to the controller;
(b) defining command signals based on the display information;
(c) sending the command signals from the device controller to one or more pixels on the second layer;
(d) displaying the display information on the one or more display pixels based on the command signals; and
(e) collecting electric power from the second and third layers based on the command signals.

29. A method of operating a self-powering device comprising:
providing the device, the device including a first layer including at least one first electrode having a first material with a first redox potential;
a second layer including at least one second electrode having a second material with a second redox potential, a metal oxide film, and a redox chromophore adsorbed to the metal oxide film; and
a third layer including at least one third electrode having a third material with a third redox potential;
the device further includes an electrolyte and the first, second, and third layers contact the electrolyte; a first switch electrically connecting the first and second layers; and a second switch electrically connecting the second and third layers; and
the first redox potential is more negative than the second redox potential and the third redox potential is more positive than the second redox potential;
the method further comprising, charging the display device by opening the first and second switches.

30. The method of claim 29 further comprising closing the first switch to transfer an electron from the first electrodes to the second electrodes and reduce the redox chromophore.

31. The method of claim 30 further comprising closing the second switch to transfer an electron from the second electrodes to the third electrodes and oxidize the redox chromophore.
